(19) United States
(12) Patent Application Publication
(10) Pub. No.: US 2010/0121633 A1
(43) Pub. Date: May 13, 2010

(54) STEREO AUDIO ENCODING DEVICE AND STEREO AUDIO ENCODING METHOD

(75) Inventor: Kok Seng Chong, Singapore (SG)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/596,489

(22) PCT Filed: Apr. 18, 2008
(86) PCT No.: PCT/JP2008/001031

§ 371 Date: Oct. 19, 2009

(30) Foreign Application Priority Data
Apr. 20, 2007 (JP) 2007-111864

(51) Int. Cl. G10L 19/00

(52) U.S. Cl. 704/220; 704/E19.001

(57) ABSTRACT

Provided is a stereo audio encoding device which can improve ICP accuracy of a stereo audio signal having a low inter-channel correlation while suppressing a bit rate. The device (100) includes: a monaural signal generation unit (101) which generates an average value of a left channel signal L and a right channel signal R as a monaural signal M; an adaptive synthesis unit (103) which generates a synthesis signal L2 of the left channel signal L and the right channel signal R by using a synthesis ratio a inputted from a synthesis ratio adjusting unit (105); LPC analysis units (102, 104) which perform LPC analysis on the monaural signal M and the synthesis signal L2 so as to generate linear prediction residual signals Me, L2e, respectively; a synthesis ratio adjusting unit (105) which firstly initializes the synthesis ratio a to 1.0 and then reduces the synthesis ratio a until the correlation value between the linear prediction residual signal L2e and Me reaches a predetermined value; and an ICP analysis unit (106) which performs ICP analysis by using Me and L2e.

### TECHNICAL FIELD

The present invention relates to a stereo speech coding apparatus that encodes stereo speech signals and a stereo speech coding method supporting this apparatus.

### BACKGROUND ART

Communication in a monophonic scheme (i.e. monophonic communication) such as a telephone call by mobile telephones is presently the mainstream in speech communication in a mobile communication system. However, if the transmission bit rate becomes higher in the future, such as with fourth-generation mobile communication systems, it is possible to secure a band to transmit a plurality of channels, so that communication in a stereophonic scheme (i.e. stereophonic communication) is expected to become widespread in speech communication.

For example, taking into account the current situation in which a growing number of users record music in a portable audio player with a built-in HDD (Hard Disk Drive) and enjoy stereo music by plugging stereo earphones or headphones in this player, a future lifestyle can be predicted in which a mobile telephone and music player are combined and in which it is common practice to perform stereo speech communication using equipment such as stereo earphones or headphones.

Even if stereo communication becomes widespread, monophonic communication will still be performed. Because monophonic communication has a lower bit rate and is therefore expected to offer lower communication costs, while mobile telephones supporting only monophonic communication has the smaller circuit scale and is therefore less expensive, and therefore users not requiring high-quality speech communication will probably purchase mobile phones supporting only monophonic communication. That is, in one communication system, mobile phones supporting stereo communication and mobile phones supporting monophonic communication exist separately, and, consequently, the communication system needs to support both stereo communication and monophonic communication. Furthermore, in a mobile communication system, depending on the propagation environment, part of communication data may be lost because communication data is exchanged by radio signals. Thus, even if part of communication data is lost, when a mobile phone is provided with a function of reconstructing the original communication data from remaining received data, it is extremely useful. As a function to support both stereo communication and monophonic communication and allow reconstruction of original communication data from receive data remaining after some communication data is lost, there is scalable coding, which supports both stereo signals and monaural signals.

In this scalable coding, techniques for synthesizing stereo signals from monaural signals include, for example, ISC (Intensity Stereo Coding) used in MPEG-2/4 AAC (Moving Picture Experts Group 2/4 Advanced Audio Coding), disclosed in Non-Patent Document 1, MPEG 4-enhanced AAC, disclosed in Non-Patent Document 2, and BCC (Binaural Cue Coding) used in MPEG surround, disclosed in Non-Patent Document 3. In these kinds of coding, when the left channel signal and right channel signal of a stereo signal are reconstructed from a monaural signal, the energy of the monaural signal is distributed between the right and left channel signals to be decoded, such that the energy ratio between the decoded right and left channel signals is equal to the energy ratio between the original left and right channel signals encoded in the coding side. Further, to enhance the sound width in these kinds of coding, reverberation components are added to reconstructed signals using a decorrelator.

Also, as another method of reconstructing a stereo signal such as the left channel signal and right channel signal from a monaural signal, there is ICP (Inter-Channel Prediction), whereby the right and left channel signals of a stereo signal are reconstructed by applying FIR (Finite Impulse Response) filtering processing to a monaural signal. Filter coefficients of a FIR filter used in ICP coding are determined based on the least mean squared error (“MSE”) such that the least mean squared error between the monaural signal and stereo signal is minimum. This stereo coding of an ICP scheme is suitable for encoding a signal with energy concentrated in lower frequencies, such as a speech signal.

Non-Patent Document 1: General Audio Coding AAC, TwinVQ, BSAC, ISO/IEC, 14496-3: part 3, subpart 4, 2005

### Non-Patent Document 2: Parametric Coding for High Quality Audio, ISO/IEC, 14496-3, 2004

### Non-Patent Document 3: MPEG Surround, ISO/IEC, 23003-1, 2006

### DISCLOSURE OF INVENTION

### Problems to be Solved by the Invention

However, stereo coding based on the ICP scheme uses the unique correlation between channels, as the information to use to predict the left channel and right channel, and, consequently, if coding of the ICP scheme is applied to a speech signal having low inter-channel correlation, there is a problem that the sound quality of decoded speech degrades. Especially, it is difficult to apply ICP to a signal in which transition of signal waveforms in the time domain is not smooth, such as a residual signal of the voiced speech signal characterized by regular pitch spikes on a noise floor.

The right and left channel signals acquired by receiving the same source signal at different positions, have different distances from the source, and therefore one channel signal is a delayed copy of the other channel signal. This delay between the right and left channels causes misalignment between pitch spikes. This alignment of pitch spikes causes the correlation between the right and left channel signals to decrease, and causes an ICP prediction not to be performed adequately. Here, ICP is not performed adequately, which causes discontinuity between frames of decoded speech and instability of stereo sound image of decoded speech.

To solve these problems, a method of increasing the ICP prediction order is suggested. However, to suppress the discontinuity between frames of decoded speech and instability of stereo sound image to an extent that does not give feeling of discomfort to listeners, the ICP order needs to increase approximately to the frame size, meaning that the bit rate increases significantly.

It is therefore an object of the present invention to provide a stereo speech coding apparatus and stereo speech coding method that can improve the ICP performance of stereo signals having low inter-channel correlation while suppressing the bit rate.

### Means for Solving the Problem

The stereo speech coding apparatus of the present invention employs a configuration having: a monaural signal generating section that generates a representative value in a form of a monaural signal, the representative value being acquired using a first channel signal and second channel signal of a stereo speech signal formed with two channel signals; a synthesis ratio adjusting section that adjusts a first channel synthesis ratio and a second channel synthesis ratio; an adaptive synthesis section that generates a first channel synthesis signal using the first channel synthesis ratio adjusted in the synthesis ratio adjusting section, the first channel signal and the second channel signal, and generates a second channel synthesis signal using the second channel synthesis ratio adjusted in the synthesis ratio adjusting section, the first channel signal and the second channel signal; and an inter-channel prediction section that performs an inter-channel prediction for a first channel using the monaural signal and the first channel synthesis signal, and further performs an inter-channel prediction for a second channel using the monaural signal and the second channel synthesis signal, and in which the synthesis ratio adjusting section adjusts the first channel synthesis ratio based on a correlation between the monaural signal and the first channel synthesis signal, and further adjusts the second channel synthesis ratio based on a correlation between the monaural signal and the second channel synthesis signal.

The stereo speech coding method of the present invention includes: a step of generating a representative value in a form of a monaural signal, the representative value being acquired using a first channel signal and second channel signal of a stereo speech signal formed with two channel signals; an synthesis ratio adjusting step of adjusting a first channel synthesis ratio and a second channel synthesis ratio; a step of generating a first channel synthesis signal using the first channel synthesis ratio adjusted in the synthesis ratio adjusting step, the first channel signal and the second channel signal, and generating a second channel synthesis signal using the second channel synthesis ratio adjusted in the synthesis ratio adjusting step, the first channel signal and the second channel signal; and a step of performing an inter-channel prediction for the first channel using the monaural signal and the first channel synthesis signal, and further performing an inter-channel prediction for the second channel using the monaural signal and the second channel synthesis signal, and in which the synthesis ratio adjusting step comprises adjusting the first channel synthesis ratio based on a correlation between the monaural signal and the first channel synthesis signal, and further adjusting the second channel synthesis ratio based on a correlation between the monaural signal and the second channel synthesis signal.

### ADVANTAGEOUS EFFECT OF INVENTION

According to the present invention, it is possible to improve the ICP performance for speech signals having low inter-channel correlation in stereo speech coding while suppressing the bit rate.

### BRIEF DESCRIPTION OF DRAWINGS

FIG. 1 is a block diagram showing the main components of a stereo speech coding apparatus according to an embodiment of the present invention;

FIG. 2 is a flowchart showing the steps of adjusting a synthesis ratio in a stereo speech coding apparatus according to an embodiment of the present invention;

FIG. 3 is a block diagram showing the main components of a stereo speech decoding apparatus according to an embodiment of the present invention;

FIG. 4 is a block diagram showing a variation example of the main components of a stereo speech coding apparatus according to an embodiment of the present invention;

FIG. 5 is block diagram showing a variation example of the main components of a stereo speech coding apparatus according to an embodiment of the present invention; and

FIG. 6 is a block diagram showing a variation example the main components of a stereo speech decoding apparatus according to an embodiment of the present invention.

### BEST MODE FOR CARRYING OUT THE INVENTION

An embodiment of the present invention will be explained below in detail with reference to the accompanying drawings.

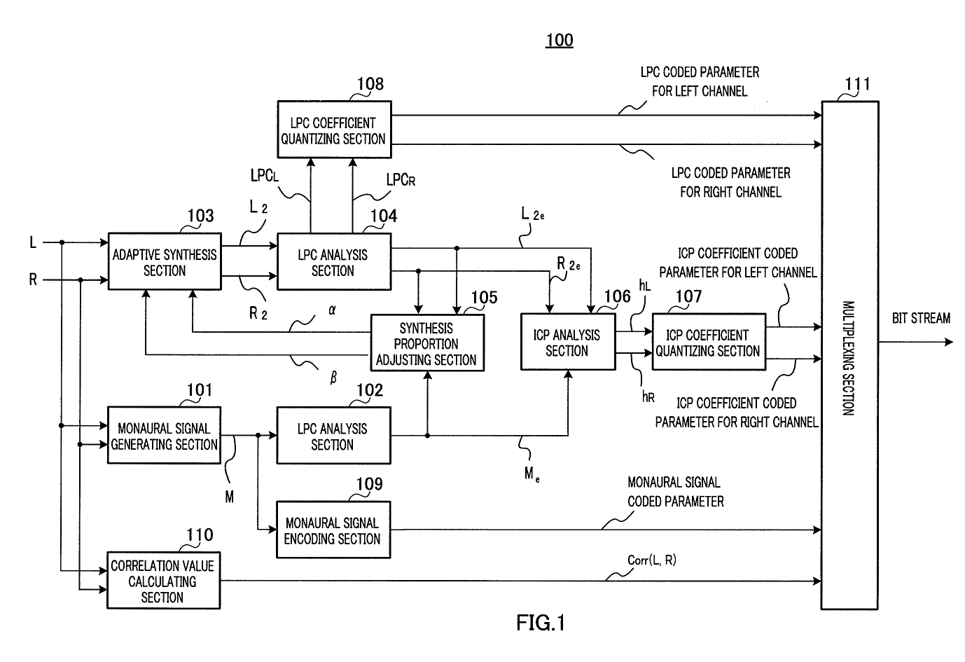

FIG. 1 is a block diagram showing the main components of stereo speech coding apparatus 100 according to an embodiment of the present invention. An example case will be explained below where a stereo signal is comprised of two channels of the left channel and right channel. Here, the notation of “left channel,” “right channel,” “L” and “R” are used for ease of explanation and do not necessarily limit the positional conditions of right and left.

In FIG. 1, stereo speech coding apparatus 100 is provided with monaural signal generating section 101, LPC (Linear Prediction Coefficients) analysis section 102, adaptive synthesis section 103, LPC analysis section 104, synthesis ratio adjusting section 105, ICP analysis section 106, ICP coefficient quantizing section 107, LPC coefficient quantizing section 108, monaural signal encoding section 109, correlation calculating section 110 and multiplexing section 111.

Monaural signal generating section 101 generates monaural signal M from a stereo speech signal received as input in stereo speech coding apparatus 100, that is, from the left channel signal L and right channel signal R, and outputs the monaural signal M to LPC analysis section 102 and monaural signal encoding section 109. As an example in the present embodiment, the monaural signal M is generated by calculating the average value of the left channel signal L and right channel signal R according to following equation 1.

M=(L+R)/2 (Equation 1)

LPC analysis section 102 performs an LPC analysis using the monaural signal M received as input from monaural signal generating section 101, determines the linear prediction residual signal Mₑ with respect to the monaural signal M using the linear prediction coefficients acquired by analysis, and outputs the linear prediction residual signal Mₑ to synthesis ratio adjusting section 105 and ICP analysis section 106.

Using the left channel synthesis ratio α that is adaptively adjusted in synthesis ratio adjusting section 105, adaptive synthesis section 103 applies the left channel signal L and right channel signal R received as input in stereo speech coding apparatus 100, to following equation 2, and generates the left channel synthesis signal L₂″. Further, adaptive synthesis section 103 adjusts the energy of the resulting left channel synthesis signal L₂″, according to following equation 3, and outputs the left channel synthesis signal L₂ with adjusted energy, to LPC analysis section 104.

$$\begin{matrix}{L}_{2}^{″} = α \cdot L + ( 1 - α ) \cdot R & ( Equation 2 ) \\ {L}_{2} = {L}_{2}^{″} \cdot \sqrt{\frac{{\sum }_{framesize} {L}^{2}}{{\sum }_{framesize} {L}_{2}^{″ 2}}} & ( Equation 3 )\end{matrix}$$

As shown in equation 2, the left channel synthesis ratio α represents the ratio between the left channel signal L and right channel signal R included in the left channel synthesis signal L₂. In equation 3, “frame size” represents the number of samples in one frame. In the energy adjustment represented by equation 3, the energy of the left channel synthesis signal L₂ is equal to the energy of the left channel signal L.

Similarly, using the right channel synthesis ratio β that is adaptively adjusted in synthesis ratio adjusting section 105, adaptive synthesis section 103 applies the left channel signal L and right channel signal R received as input in stereo speech coding apparatus 100, to following equation 4, and generates the right channel synthesis signal R₂″. Further, adaptive synthesis section 103 adjusts the energy of the resulting right channel synthesis signal R₂″, according to following equation 5, and outputs the right channel synthesis signal R₂ with adjusted energy, to LPC analysis section 104.

$$\begin{matrix}{R}_{2}^{″} = β \cdot R + ( 1 - β ) \cdot L & ( Equation 4 ) \\ {R}_{2} = {R}_{2}^{″} \cdot \sqrt{\frac{{\sum }_{framesize} {R}^{2}}{{\sum }_{framesize} {R}_{2}^{″ 2}}} & ( Equation 5 )\end{matrix}$$

LPC analysis section 104 performs an LPC analysis of the left channel synthesis signal L₂ received as input from adaptive synthesis section 103, and outputs the resulting linear prediction coefficients for the left channel, LPC_{L}, to LPC coefficient quantizing section 108. Similarly, LPC analysis section 104 performs an LPC analysis of the right channel synthesis signal R₂ received as input from adaptive synthesis section 103, and outputs the resulting linear prediction coefficients for the right channel, LPC_{R}, to LPC coefficient quantizing section 108. Further, using the resulting linear prediction coefficients for the left channel, LPC_{L}, LPC analysis section 104 determines and outputs the linear prediction residual signal L₂ₑ with respect to the left channel synthesis signal L₂, to synthesis ratio adjusting section 105 and ICP analysis section 106. Similarly, using the resulting linear prediction coefficients for the right channel, LPC_{R}, LPC analysis section 104 determines and outputs the linear prediction residual signal R₂ₑ with respect to the right channel synthesis signal R₂, to synthesis ratio adjusting section 105 and ICP analysis section 106.

First, synthesis ratio adjusting section 105 initializes the left channel synthesis ratio α to “1.0.” Next, if the correlation value per frame, Corr_{L} (L₂ₑ, Mₑ), between the linear prediction residual signal L₂ₑ received as input from LPC analysis section 104 and the linear prediction residual signal Mₑ received as input from LPC analysis section 102, is lower than a predetermined threshold, synthesis ratio adjusting section 105 reduces and outputs the left channel synthesis ratio α to adaptive synthesis section 103. Similarly, first, synthesis ratio adjusting section 105 initializes the right channel synthesis ratio β to “1.0.” Next, if the correlation value per frame, Corr_{R} (R₂ₑ, Mₑ), between the linear prediction residual signal R₂ₑ received as input from LPC analysis section 104 and the linear prediction residual signal Mₑ received as input from LPC analysis section 102, is lower than a predetermined threshold, synthesis ratio adjusting section 105 reduces and outputs the right channel synthesis ratio β to adaptive synthesis section 103. Thus, synthesis ratio adjusting section 105 performs loop processing for adjusting the synthesis ratios α and β together with adaptive synthesis section 103 and LPC analysis section 104, until the correlation values Corr_{L} (L₂ₑ, Mₑ) and Corr_{R} (R₂ₑ, Mₑ) are both equal to or higher than a predetermined threshold. Synthesis ratio adjusting section 105 calculates the correlation values Corr_{L} (L₂ₑ, Mₑ) and Corr_{R} (R₂ₑ, Mₑ) according to following equations 6 and 7, respectively.

$$\begin{matrix}{Corr}_{L} ( {L}_{2 e} , {M}_{e} ) = \frac{{\sum }_{frame} {L}_{2 e} {M}_{e}}{\sqrt{{\sum }_{frame} {L}_{2 e}^{2} {\sum }_{frame} {M}_{e}^{2}}} & ( Equation 6 ) \\ {Corr}_{R} ( {R}_{{2}_{e}} , {M}_{e} ) = \frac{{\sum }_{frame} {R}_{{2}_{e}} {M}_{e}}{\sqrt{{\sum }_{frame} {R}_{2 e}^{2} {\sum }_{frame} {M}_{e}^{2}}} & ( Equation 7 )\end{matrix}$$

ICP analysis section 106 calculates the left channel ICP coefficient h_{L}, using the linear prediction residual signal L₂ₑ received as input from LPC analysis section 104 and the linear prediction residual signal Mₑ received as input from LPC analysis section 102, and outputs the left channel ICP coefficient h_{L}, to ICP coefficient quantizing section 107. This left channel ICP coefficient h_{L}, is the FIR coefficient of the N-th order for predicting the linear prediction residual signal L₂ₑ from the linear prediction residual signal Mₑ, and, when the prediction signal with respect to the linear prediction residual signal L₂ₑ is L̂₂ₑ, the prediction signal is represented by following equation 8.

$${\hat{L}}_{2 e} ( n ) = {\sum }_{i = 0}^{N - 1} {h}_{L} ( i ) {M}_{e} ( n - i ) \qquad ( Equation 8 )$$

In equation 8, “n” represents the sample numbers of the linear prediction residual signals Mₑ and L₂ₑ, and “N” represents the order of FIR filter coefficients. Here, the FIR filter coefficient h_{L}(i) is determined based on the least mean squared error. To be more specific, h_{L}(i) is a value that minimizes the mean squared error ε represented by following equation 9, and that therefore satisfies following equation 10. By calculating equation 10, h_{L}, represented by equation 11 is acquired.

$$\begin{matrix}ξ = {\sum }_{n = 0}^{framesize - 1} {( {L}_{2 e} ( n ) - {\hat{L}}_{2 e} ( n ) )}^{2} & ( Equation 9 ) \\ \frac{\partial ξ}{\partial {h}_{L}} = 0 & ( Equation 10 ) \\ {h}_{L} = {( {M}_{e} {M}_{e}^{T} )}^{- 1} ( {M}_{e} {L}_{2 e} ) & ( Equation 11 )\end{matrix}$$

Further, using the linear prediction residual signal R₂ₑ received as input from LPC analysis section 104 and linear prediction residual signal Mₑ received as input from LPC analysis section 102, ICP analysis section 106 determines the right channel ICP coefficient h_{R} in the same way as the method of determining the left channel ICP coefficient h_{L}, and outputs the right channel ICP coefficient h_{R} to ICP coefficient quantizing section 107.

ICP coefficient quantizing section 107 quantizes the left channel ICP coefficient h_{L}, and right channel ICP coefficient h_{R} received as input from ICP analysis section 106, and outputs the ICP coefficient coded parameter for the left channel and the ICP coefficient coded parameter for the right channel to multiplexing section 111.

LPC coefficient quantizing section 108 quantizes the linear prediction coefficients for the left channel, LPC_{L}, and the linear prediction coefficients for the right channel, LPC_{R} received as input from LPC analysis section 104, and outputs the LPC coded parameter for the left channel and the LPC coded parameter for the right channel to multiplexing section 111.

Monaural signal encoding section 109 encodes the monaural signal M received as input from monaural signal generating section 101 by an arbitrary coding scheme, and outputs the resulting monaural signal coded parameter to multiplexing section 111.

Correlation value calculating section 110 calculates the correlation value per frame, Corr (L, R), between the left channel signal L and right channel signal R received as input in stereo speech coding apparatus 100, according to following equation 12, and outputs the results to multiplexing section 111.

$$Corrr ( L , R ) = \frac{{\sum }_{frame} LR}{\sqrt{{\sum }_{frame} {L}^{2} {\sum }_{frame} {R}^{2}}} \qquad ( Equation 12 )$$

Multiplexing section 111 multiplexes the ICP coefficient coded parameter for the left channel and ICP coefficient coded parameter for the right channel received as input from ICP coefficient quantizing section 107, the LPC coded parameter for the left channel and LPC coded parameter for the right channel received as input from LPC coefficient quantizing section 108, the monaural signal coded parameter received as input from monaural signal encoding section 109 and the correlation value Corr (L, R) received as input from correlation value calculating section 110, and outputs the resulting bit stream to stereo speech decoding apparatus 200, which will be described later.

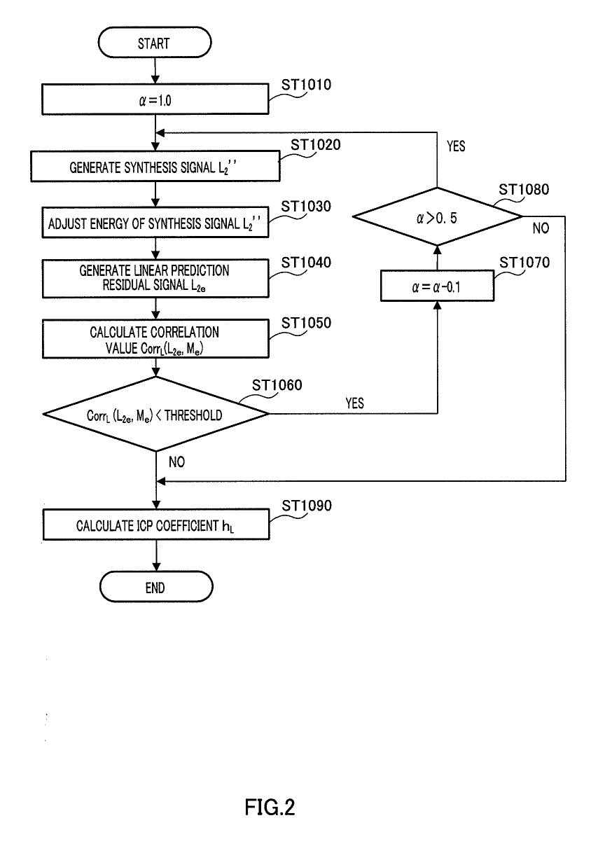

FIG. 2 is a flowchart showing the steps of adjusting the synthesis ratio α and β in stereo speech coding apparatus 100. Here, although the steps of adjusting the left channel synthesis ratio α will be explained with this figure as an example, the steps of adjusting the right channel synthesis ratio β are basically the same as the steps in this figure, where α, L₂″, L₂ₑ and h_{L} are replaced with β, R₂″, R₂ₑ and h_{R}, respectively.

In step (hereinafter abbreviated to “ST”) 1010, synthesis ratio adjusting section 105 initializes the synthesis ratio α to “1.0.”

Next, in ST 1020, adaptive synthesis section 103 generates the synthesis signal L₂″ according to equation 2.

Next, in ST 1030, adaptive synthesis section 103 performs an energy adjustment of the synthesis signal L₂″ according to equation 3 and acquires the synthesis signal L₂.

Next, in ST 1040, LPC analysis section 104 performs an LPC analysis of the synthesis signal L₂ and generates the linear prediction residual signal L₂ₑ.

Next, in ST 1050, synthesis ratio adjusting section 105 calculates the correlation value Corr_{L} (L₂ₑ, Mₑ) between the linear prediction residual signal L₂ₑ received as input from LPC analysis section 104 and the linear prediction residual signal Mₑ received as input from LPC analysis section 102.

Next, in ST 1060, synthesis ratio adjusting section 105 decides whether or not the correlation value Corr_{L} (L₂ₑ, Mₑ) is lower than a predetermined threshold.

In ST 1060, if the correlation value Corr_{L}, (L₂ₑ, Mₑ) is decided to be lower than the predetermined threshold (“YES” in ST 1060), in ST 1070, synthesis ratio adjusting section 105 adjusts the synthesis ratio α to α=α−0.1.

Next, in ST 1080, synthesis ratio adjusting section 105 decides whether or not the synthesis ratio α is higher than “0.5.”

In ST 1080, if the synthesis ratio α is decided to be higher than “0.5” (“YES” in ST 1080), the processing step proceeds to ST 1020.

By the decision processing in this step, the synthesis ratio α is limited to the range of 0.5≦α≦1.0. Here, when the value of the synthesis ratio α is equal to “1.0,” the synthesis signal L2 and monaural signal M are the most different from each other, and therefore the ICP prediction performance degrades most significantly. By contrast, when the value of the synthesis ratio α is closer to “0.5,” the synthesis signal L2 and monaural signal M become closer to each other, so that the ICP prediction performance is improved. Here, it is needless to say that the value to compare with synthesis ratios is not limited to “0.5” in the above and can be set to an appropriate value adequately.

On the other hand, if the correlation value Corr_{L} (L₂ₑ, Mₑ) is decided to be equal to or higher than a threshold in ST 1060 (“NO” in ST 1060) or if the synthesis ratio α is decided to be equal to or lower than “0.5” in ST 1080 (“NO” in ST 1080), ICP analysis section 106 calculates the ICP coefficient h_{L}, using the linear prediction residual signal L₂ₑ received as input from LPC analysis section 104 and the linear prediction residual signal Mₑ received as input from LPC analysis section 102.

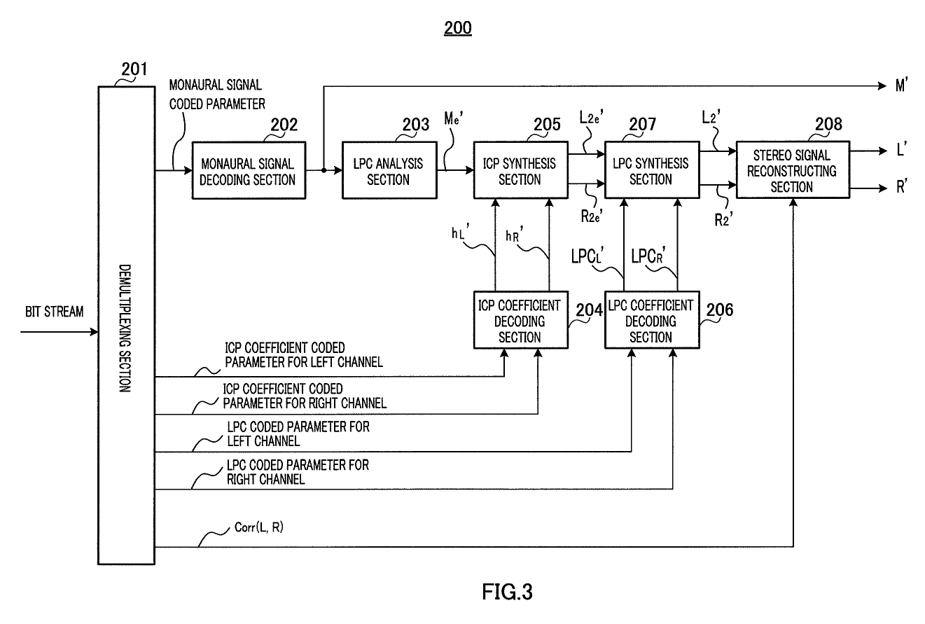

FIG. 3 is a block diagram showing the main components of stereo speech decoding apparatus 200 according to the present embodiment.

In FIG. 3, stereo speech decoding apparatus 200 is provided with demultiplexing section 201, monaural signal decoding section 202, LPC analysis section 203, ICP coefficient decoding section 204, ICP synthesis section 205, LPC coefficient decoding section 206, LPC synthesis section 207 and stereo signal reconstructing section 208.

Demultiplexing section 201 demultiplexes the bit stream transmitted from stereo speech coding apparatus 100 into the monaural signal coded parameter, the ICP coefficient coded parameter for the left channel, the ICP coefficient coded parameter for the right channel, the LPC coded parameter for the left channel, the LPC coded parameter for the right channel and the correlation value Corr (L, R). Further, demultiplexing section 201 outputs the monaural signal coded parameter to monaural signal decoding section 202, the ICP coefficient coded parameter for the left channel and the ICP coefficient coded parameter for the right channel to ICP coefficient decoding section 204, the LPC coded parameter for the left channel and the LPC coded parameter for the right channel to LPC coefficient decoding section 206, and the correlation value Corr (L, R) to stereo signal reconstructing section 208.

Monaural signal decoding section 202 performs decoding by a scheme supporting the coding scheme on the coding side, using the monaural signal coded parameter received as input from demultiplexing section 201, outputs the acquired decoded monaural signal M′ to LPC analysis section 203, and, if necessary, outputs it to the outside of stereo speech decoding apparatus 200.

LPC analysis section 203 performs an LPC analysis using the decoded monaural signal M′ received as input from monaural signal decoding section 202, determines the decoded linear prediction residual signal Mₑ′ with respect to the decoded monaural signal M′ using the linear prediction coefficients acquired by the analysis, and outputs the decoded linear prediction residual signal Mₑ′ to ICP synthesis section 205.

ICP coefficient decoding section 204 decodes the ICP coefficient coded parameter for the left channel and the ICP coefficient coded parameter for the right channel received as input from demultiplexing section 201, and outputs the resulting decoded ICP coefficients h_{L}′ and h_{R}′ to ICP synthesis section 205.

ICP synthesis section 205 performs an ICP synthesis using the decoded linear prediction residual signal Mₑ′ received as input from LPC analysis section 203 and the decoded ICP coefficient h_{L}′ received as input from ICP coefficient decoding section 204, and outputs the resulting linear prediction residual signal L₂ₑ′ to LPC synthesis section 207. Similarly, ICP synthesis section 205 performs an ICP synthesis using the decoded linear prediction residual signal Mₑ′ received as input from LPC analysis section 203 and the decoded ICP coefficient h_{R}′ received as input from ICP coefficient decoding section 204, and outputs the resulting linear prediction residual signal R₂ₑ′ to LPC synthesis section 207.

LPC coefficient decoding section 206 decodes the LPC coded parameter for the left channel and the LPC coded parameter for the right channel received as input from demultiplexing section 201, and outputs the resulting decoded linear prediction coefficients LPC_{L}′ and LPC_{R}′ to LPC synthesis section 207.

LPC synthesis section 207 performs an LPC synthesis using the linear prediction residual signal L₂ₑ′ received as input from ICP synthesis section 205 and the decoded linear prediction coefficient LPC_{L}′ received as input from LPC coefficient decoding section 206, and outputs the resulting decoded synthesis signal L₂′ to stereo signal reconstructing section 208. Further, LPC synthesis section 207 performs an LPC synthesis using the linear prediction residual signal R₂′ received as input from ICP synthesis section 205 and the decoded linear prediction coefficient LPC_{R}′ received as input from LPC coefficient decoding section 206, and outputs the resulting decoded synthesis signal R₂′ to stereo signal reconstructing section 208.

Stereo signal reconstructing section 208 reconstructs the decoded left channel signal L′ and decoded right channel signal R′ forming a stereo signal, using the decoded synthesis signals L₂′ and R₂′ received as input from LPC synthesis section 207 and the correlation value Corr (L, R) received as input from demultiplexing section 201, and outputs the decoded left channel signal L′ and decoded right channel signal R′ to the outside of stereo speech decoding apparatus 200.

Processing of reconstructing stereo signals in stereo signal reconstructing section 208 will be explained below in detail.

The correlation value Corr (L₂′, R₂′) between the decoded synthesis signal L₂′ and decode synthesis signal R₂′ received as input in stereo signal reconstructing section 208, is generally higher than the correlation value Corr (L, R) received as input from demultiplexing section 201.

Here, when the correlation between the right and left channels of a stereo signal is higher, the stereo sound image of the stereo signal becomes narrower. Therefore, stereo signal reconstructing section 208 further adds perceptually orthogonal reverberation components to the decoded synthesis signal L₂′ and decoded synthesis signal R₂′, using the correlation value Corr (L, R) received as input from demultiplexing section 201, and outputs the results in the form of a stereo signal. Here, the reverberation components are the components for spatial enhancement of a stereo signal, and can be calculated by allpass filters or allpass filter lattices. For example, stereo signal reconstructing section 208 reconstructs the left channel signal L′ and right channel signal R′ according to following equations 13 and 14.

L′=c·L₂′+\sqrt{1−c²}·AP₁(L₂′) (Equation 13)

R′=c·R₂′+\sqrt{1−c²}·AP₂(R₂′) (Equation 14)

In equations 13 and 14, AP₁(L₂′) and AP₂(R₂′) represent the transfer functions of two different allpass filters, and “c” represents the value shown in following equation 15. Here, to improve a stereo sound image, it may be preferable to divide the left and right channel signals of a stereo signal into a plurality of frequency bands and apply respective allpass filters to the frequency bands.

$$c = \sqrt{\vert \frac{Corr ( L , R )}{Corr ( {L}_{2}^{′} , {R}_{2}^{′} )} \vert} \qquad ( Equation 15 )$$

Thus, according to the present embodiment, the stereo speech coding apparatus generates a synthesis signal of a left channel signal and right channel signal and performs an ICP using the monaural signal and synthesis signal such that the correlation value between a monaural signal and the synthesis signal is equal to or higher than a predetermined threshold, so that, without increasing the ICP order, it is possible to suppress the bit rate, improve ICP performance with respect to a stereo signal having lower inter-channel correlation, and, consequently, improve the sound quality of the decoded speech signal.

Here, although an example case has been described above with the present embodiment where “0.1” is used in the step of adjusting the synthesis ratio α, the present invention is not limited to this, and it is equally possible to use an arbitrary value in the step of adjusting the synthesis ratio α such as a smaller value, “0.05.”

Also, to avoid sound instability in very dynamic speech signals, it is possible to set the adjustment range of the synthesis ratio α of the current frame to αₚᵣₑᵥ_{_{—}}_{frame}−ρ≦α≦αₚᵣₑᵥ_{_{—}}_{frame}+ρ, based on the synthesis ratio αₚᵣₑᵥ_{_{—}}_{frame} used in ICP of the previous frame. Here, ρ is a real number.

Also, although a case has been described above with the present embodiment where monaural signal encoding section 109 performs coding by an arbitrary coding scheme, when monaural signal encoding section 109 is an encoder adopting a CELP (Code Excited Linear Prediction) scheme or an arbitrary encoder which provides processing of generating a linear prediction residual signal (i.e. excitation signal), stereo speech coding apparatus 100 needs not to have LPC analysis section 102.

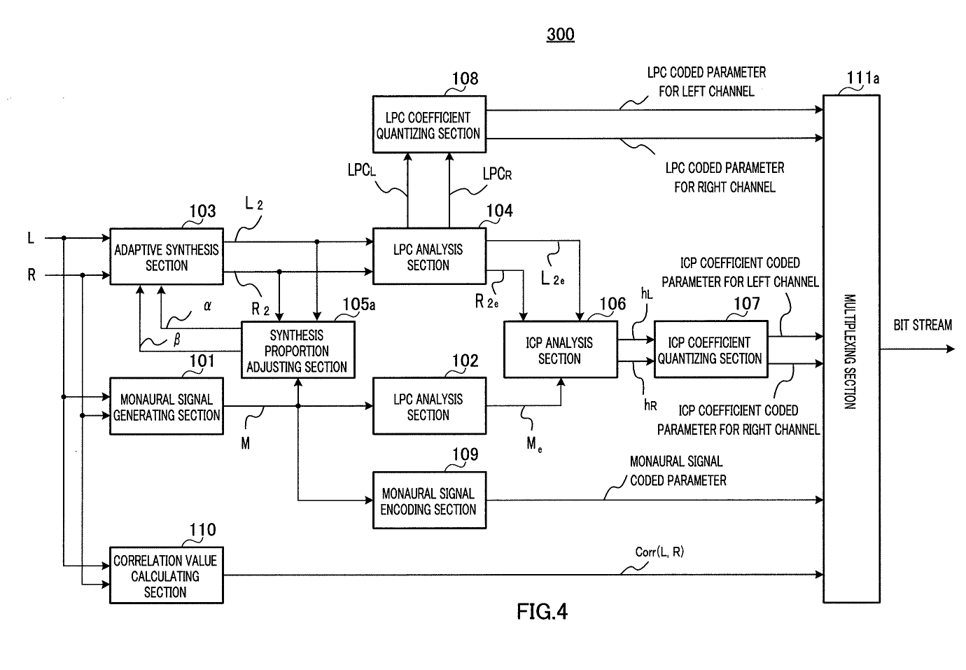

Also, although an example case has been described above with the present embodiment where synthesis ratio adjusting section 105 adjusts the synthesis ratio α based on the correlation value between the linear prediction residual signal L₂ₑ and the linear prediction residual signal Mₑ, the present invention is not limited to this, and, as in stereo speech coding apparatus 300 shown in FIG. 4, synthesis ratio adjusting section 105a may adjust the synthesis ratio α based on the correlation value between the synthesis signal L₂ and the monaural signal M. The same applies to the synthesis ratio β.

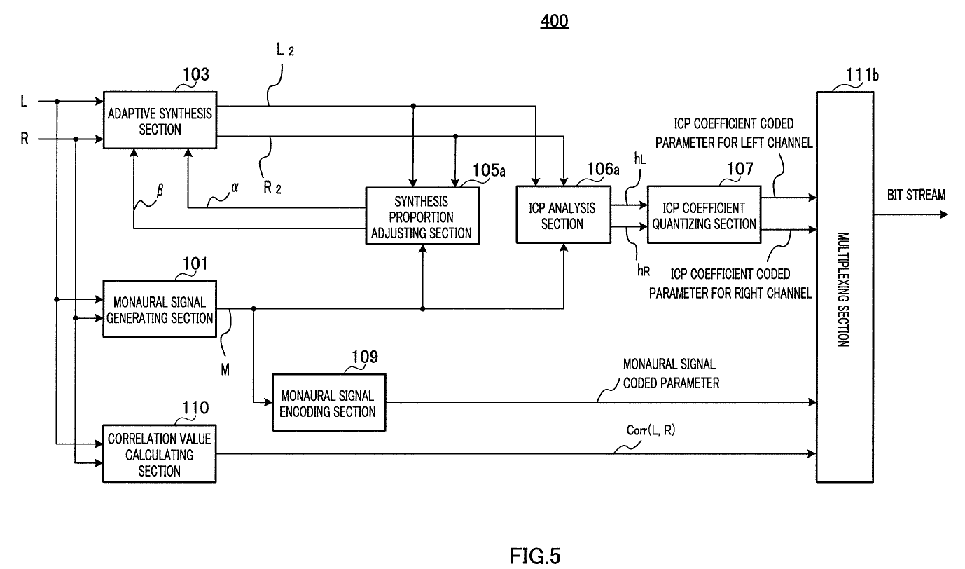

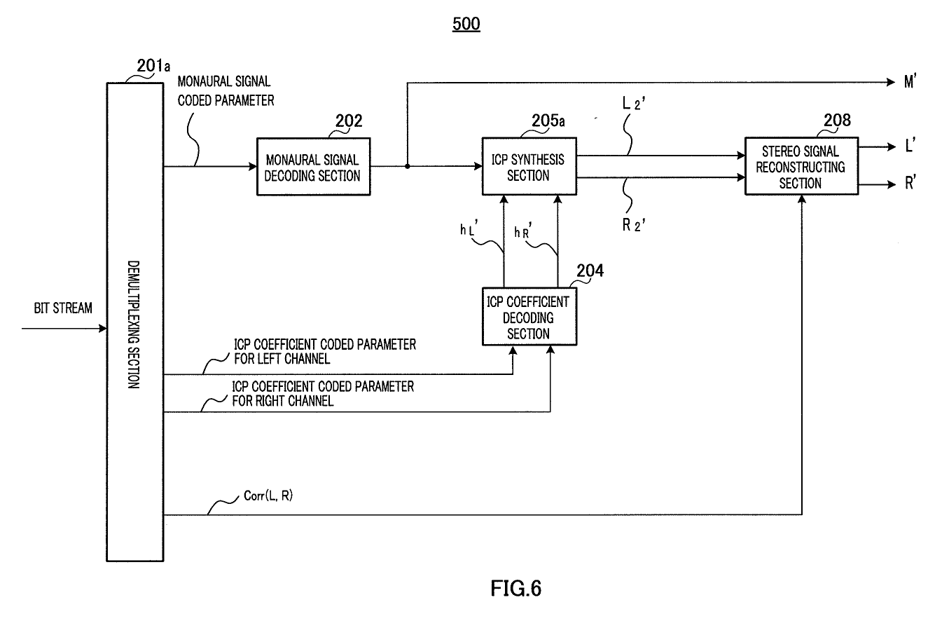

Also, an example case has been described above with the present embodiment where stereo speech coding apparatus 100 further performs an LPC analysis before performing coding by an ICP scheme, the stereo speech coding apparatus according to the present invention is not limited to this, and may employ a configuration not performing an LPC analysis as in stereo speech coding apparatus 400 shown in FIG. 5, thereby simplifying coding processing and reducing the amount of calculations. In this case, the configuration of stereo speech decoding apparatus 500 is as shown in FIG. 6.

Also, an example case has been described above with the present embodiment where a stereo signal is comprised of two channel signals of the left channel signal L as the first channel signal and the right channel signal R as the second channel signal, the present invention is not limited to this, and “L” and “R” may be reversed, or a stereo signal may be comprised of three or more signals. In this case, the average value of three or more channel signals is generates in a form of the monaural signal M, and the synthesis signal L₂ is generated using three or more channel signals. Here, although M represents an average value with the present embodiment, the present invention is not limited to this, and M may be a representative value that can be adequately calculated using L and R.

Also, although the stereo speech decoding apparatus of the present embodiment has been described to perform processing using a bit stream transmitted from the stereo speech coding apparatus according to the present embodiment, the present invention is not limited to this, and, if the bit stream includes necessary parameters and data, the processing is possible even when the bit stream is not transmitted from the stereo speech coding apparatus according to the present embodiment.

The stereo speech coding apparatus and stereo speech decoding apparatus according to the present invention can be mounted on a communication terminal apparatus in a mobile communication system, so that it is possible to provide a communication terminal apparatus having the same operational effect as described above. Also, the stereo speech coding apparatus and stereo speech coding method according to the present embodiment are available in a communication system of a wired system.

Also, although an example case has been described above with this description where the preset invention is applied to monaural-to-stereo scalable coding, it is equally possible to employ a configuration where the present invention is applied to coding/decoding per band upon performing band split coding of stereo signals.

Although a case has been described above with the above embodiments as an example where the present invention is implemented with hardware, the present invention can be implemented with software. For example, by describing the stereo speech coding method according to the present invention in a programming language, storing this program in a memory and making the information processing section execute this program, it is possible to implement the same function as the stereo speech coding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-111864, filed on Apr. 20, 2007, including the specification, drawings and abstract, is incorporated herein by reference in its entirety.

### INDUSTRIAL APPLICABILITY

The stereo speech coding apparatus and stereo speech coding method according to the present embodiment are applicable to, for example, a communication terminal apparatus in a mobile communication system.

1. A stereo speech coding apparatus comprising:
a monaural signal generating section that generates a representative value in a form of a monaural signal, the representative value being acquired using a first channel signal and second channel signal of a stereo speech signal formed with two channel signals;
a synthesis ratio adjusting section that adjusts a first channel synthesis ratio and a second channel synthesis ratio;
an adaptive synthesis section that generates a first channel synthesis signal using the first channel synthesis ratio adjusted in the synthesis ratio adjusting section, the first channel signal and the second channel signal, and generates a second channel synthesis signal using the second channel synthesis ratio adjusted in the synthesis ratio adjusting section, the first channel signal and the second channel signal; and
an inter-channel prediction section that performs an inter-channel prediction for a first channel using the monaural signal and the first channel synthesis signal, and further performs an inter-channel prediction for a second channel using the monaural signal and the second channel synthesis signal,
wherein the synthesis ratio adjusting section adjusts the first channel synthesis ratio based on a correlation between the monaural signal and the first channel synthesis signal, and further adjusts the second channel synthesis ratio based on a correlation between the monaural signal and the second channel synthesis signal.

2. The stereo speech coding apparatus according to claim 1, wherein the synthesis ratio adjusting section adjusts the first channel synthesis ratio such that a first correlation value that is a correlation value between the monaural signal and the first channel synthesis signal is equal to or higher than a predetermined threshold, and adjusts the second channel synthesis ratio such that a second correlation value that is a correlation value between the monaural signal and the second channel synthesis signal is equal to or higher than a predetermined threshold

3. The stereo speech coding apparatus according to claim 1, further comprising a linear prediction analysis section that generates a first linear prediction residual signal with respect to the monaural signal using a first linear prediction coefficient acquired by performing a linear prediction analysis of the monaural signal, generates a second linear prediction residual signal with respect to the first channel synthesis signal using a second linear prediction coefficient acquired by performing the linear prediction analysis of the first channel synthesis signal, and generates a third linear prediction residual signal with respect to the second channel synthesis signal using a third linear prediction coefficient acquired by performing the linear prediction analysis of the second channel synthesis signal,
wherein the synthesis ratio adjusting section adjusts the first channel synthesis ratio such that a third correlation value that is a correlation value between the first linear prediction residual signal and the second linear prediction residual signal is equal to or higher than a predetermined threshold, and adjusts the second channel synthesis ratio such that a fourth correlation value that is a correlation value between the first linear prediction residual signal and the third linear prediction residual signal is equal to or higher than a predetermined threshold.

4. The stereo speech coding apparatus according to claim 3, wherein the synthesis ratio adjusting section sets initial values of the first channel synthesis ratio and the second channel synthesis ratio, adjusts the first channel synthesis ratio by reducing the first channel synthesis ratio until the third correlation value is equal to or higher than the predetermined threshold value, and adjusts the second channel synthesis ratio by reducing the second channel synthesis ratio until the fourth correlation value is equal to or higher than the predetermined threshold value.

5. The stereo speech coding apparatus according to claim 1, wherein the synthesis ratio adjusting section adds a predetermined value to the first channel synthesis ratio for generating the first channel synthesis signal used in an inter-channel prediction of a past frame and sets an addition result as an initial value of the first channel synthesis ratio, and further adds a predetermined value to the second channel synthesis ratio for generating the first channel synthesis signal used in the inter-channel prediction of the past frame and sets an addition result as an initial value of the second channel synthesis ratio.

6. A stereo speech coding method comprising:
a step of generating a representative value in a form of a monaural signal, the representative value being acquired using a first channel signal and second channel signal of a stereo speech signal formed with two channel signals;
an synthesis ratio adjusting step of adjusting a first channel synthesis ratio and a second channel synthesis ratio;
a step of generating a first channel synthesis signal using the first channel synthesis ratio adjusted in the synthesis ratio adjusting step, the first channel signal and the second channel signal, and generating a second channel synthesis signal using the second channel synthesis ratio adjusted in the synthesis ratio adjusting step, the first channel signal and the second channel signal; and
a step of performing an inter-channel prediction for the first channel using the monaural signal and the first channel synthesis signal, and further performing an inter-channel prediction for the second channel using the monaural signal and the second channel synthesis signal,
wherein the synthesis ratio adjusting step comprises adjusting the first channel synthesis ratio based on a correlation between the monaural signal and the first channel synthesis signal, and further adjusting the second channel synthesis ratio based on a correlation between the monaural signal and the second channel synthesis signal.
